(19) United States
(12) Patent Application Publication
(10) Pub. No.: US 2016/0101706 A1
(43) Pub. Date: Apr. 14, 2016

(54) Charging System for Electric Vehicles

(71) Applicant: Carl Lee Danner, Bakersfield, CA (US)

(72) Inventor: Carl Lee Danner, Bakersfield, CA (US)

(21) Appl. No.: 14/513,213

(22) Filed: Oct. 14, 2014

(51) Int. Cl. B60L 11/18

(52) U.S. Cl. CPC B60L 11/1846; B60L 11/1816

(57) ABSTRACT

Systems composed of chargers that allow vehicles to control parameters of power, or that allow vehicles to receive power having parameters the power connector usually is used for, or parameters that a charger estimated based on voltage that the charger measures at the vehicle's connector, or that has parameters that a charger calculated based information about the vehicle's energy storage device that the vehicle sends to the charger.

This application is a continuation of application Ser. No. 13/712,967 and a continuation of application Ser. No. 13/942,649

### FIELD OF THE INVENTION

Electric vehicle charging systems

### BACKGROUND OF THE INVENTION

The present electric vehicle power delivery system is composed of many incompatible chargers and power outlets. Each charger uses a unique power connector because the power that the charger provides is not controllable. Vehicles must charge at a charger that provides charging power with appropriate parameters. Vehicle charging station companies find it impractical to put all these incompatible chargers in one charging station. As a result most charging stations only support a small fraction of proprietary chargers.

### SUMMARY OF THE INVENTION

This charging system is based on chargers that have a controllable power output. Vehicles can use different types of signals to control charging power. An interesting variation is that a vehicle could upload specifications of its energy storage device. The vehicle could also provide energy storage device status such as temperature or fraction of charge remaining in the storage device. An intelligent charger could then control the controllable power source so as to provide appropriate power.

Also chargers can generate control signals. An example is that a vehicle may use a proprietary power connector that normally provides charging power that has specific parameters. A charger in the system can generate a control signal to tell a controllable power source to provide the appropriate power. Also a charge can provide an estimated charging power by measuring the voltage at a vehicle's power input connector. The charger can generate a control signal to tell the controllable power source to provide a charging power that is slightly higher voltage than the voltage that was measured at the vehicle's power input connector.

New types of power control signals can be added to the system because some chargers in the system have means of identifying control signals. New vehicles that need different charging power can control the charger to get power that they need.

### BRIEF DESCRIPTION OF THE DRAWINGS

The foregoing and other objects and features of the present invention can be more readily understood with reference to the following description, taken in conjunction with the accompanying drawings, wherein like reference alpha-numerics identify like electrical elements or signals and in which dotted lines represent signal paths. Solid lines represent power delivery paths. A number or letter preceded by a dash is a signal format. For example 104-7 indicates signal 104 that is in format 7.

FIG. 1 is a block diagram of an electric vehicle (100) that is controlling a simple charger. The reason I say the charger is simple is that this charger can only understand signals that are in one format. The vehicle is using a power source control signal that is generated by a device associated with the vehicle's battery. The signal must be in a format that the controllable power source can understand. The device monitors battery status and then uses that and other information such as battery specifications to develop a power source control signal. The power source control signal is in a format that the controllable power source understands. If this power source does not receive a power source control signal that is in the correct format then the power source will probably provide power having wrong parameters or the charger could be damaged.

FIG. 2 shows a vehicle with different power needs. This vehicle is sending a power source control signal to the same charger that the vehicle in FIG. 1 was using. This power source control signal is in the same format as the signal that the vehicle in FIG. 1 was using. The vehicle's energy storage device is different than the energy storage device of the vehicle in FIG. 1 so it needs charging power that has different power parameter values. The signal is controlling the power source so power having different parameters is delivered.

FIG. 3 is a another vehicle with different power needs. This vehicle is trying to send a standard power source control signal to the same charger that the vehicles in FIG. 1 and FIG. 2 were using. The vehicle's signal connector does not match the charger's signal input connector. The incompatible connectors are needed because the charger does not understand standard power control signals. The charger or vehicle could be damaged if a standard power control signal were delivered. Even if no damage occurred the delivered power would not have correct parameters.

FIG. 4 shows the vehicle of FIG. 3 obtaining power from the charger in FIGS. 1 to 3, but now a translator has been added to the charger. The translator translates the standard power control signal that the vehicle is sending into a format that the controllable power source can use. The source is delivering correct power. This charger also has the same signal connector as the chargers in FIGS. 1 to 3.

FIG. 5 Now the same vehicle that obtained power in FIG. 4 is using the same standard power control signal to obtain power from another charger that understands standard power control signals. The charger's translator is translating the vehicle's standard power control signal into a different format that is able to control the different type of controllable power source in the charger.

The vehicle is obtaining correct power. This charger has a signal connector that allows the controllable power source to be directly controlled. The connector is of a type that is different from the connector of the chargers in FIGS. 1 to 4 because the different controllable power source needs a different type power control signal for proper power to be delivered. Each type controllable power source must be protected from receiving a control signal that is intended for another type controllable power source.

FIG. 6 This is a charger that understands many types of power control signals. A vehicle is transmitting a type of power control signal to an identifier. The identifier recognizes the signal, removes the signal identification code and sends the power control signal to the translator. The translator translates the signal into a format that can control the controllable power source. The controllable power source is delivering correct power to the vehicle's energy storage device. This charger would probably be able to understand a standard power control signal because a standard power control signal may have a recognizable format.

FIG. 7 is a vehicle that is transmitting a different type power control signal to the same charger as in FIG. 6. An identifier recognizes the type power control, removes the identification code, and sends the signal to a translator that translates it into the same format as that used in FIG. 6. Correct power that has different parameters is being delivered to the vehicle's energy storage device.

FIG. 8 is the same charger as in FIG. 7. Now a different vehicle is directly controlling the controllable power source. The vehicle is using a signal input connector that is unique to the type controllable power source. Correct power is being delivered.

FIG. 9 shows a charger that can receive a power control signal or can generate an estimated power control signal. In this case the vehicle's power control signal plug does not mate the charger's power parameter input plug. The charger internal signal generator creates and estimated power control signal based on voltage and amperage readings taken near the power delivery plug. The internal signal generator is sending the estimated power control signal to the controllable power source. The controllable power source creates an estimated power and delivers it to the battery. The same vehicle as in FIG. 8 is receiving acceptable power. The power does not have exactly the parameters as the power in FIG. 8 because the charger does not have access to the vehicle's energy storage device specifications. The charger only has voltage and current information. It is likely that less power is being delivered because the estimated power has to be a conservative estimate so the vehicle's energy storage device will not be damaged.

FIG. 10 is a charger that can either use a power control signal or can automatically generate an estimated power control signal. Here the charger is receiving a power control signal from the same vehicle that received power in FIG. 7. The identifier does not recognize the identification code and blocks the power control signal. An internal signal generator senses the presence of a vehicle by receiving voltage detected by a voltmeter. The internal signal generator uses the voltage to create an estimated power control signal. The internal signal generator sends the estimated power control signal to a signal selector. The signal selector is only receiving one signal which is the estimated power control signal so it sends the estimated signal to the translator. The Translator passes it unchanged to the controllable power supply. The controllable power supply generates power having parameters as specified by the estimated power control signal. The power being supplied to the vehicle has somewhat different parameters than the power that the vehicle received in FIG. 7.

FIG. 11 is a charger that is able to understand power control signals, able to create estimated power, and also able to simulate the operation of proprietary chargers that use a special power connector to tell the charger what power parameters the vehicle uses to charge. A proprietary vehicle is using a proprietary power connector to obtain power. Notice that the vehicle does not have a signal generator. The vehicle only has a battery and a proprietary power connector. The internal signal generator knows which connector the vehicle is using because it is receiving a voltage from a voltmeter on the power delivery line to the connector. The signal generator has information about the proprietary charger that uses the proprietary connector. More than likely the manufacturer of the charger that uses the proprietary connector will create the program that the internal signal generator uses to create a proprietary power control signal. The signal generator creates and sends the proprietary power control signal to a selector. The selector chooses between an externally generated signal which it would receive from an identifier and the internally generated signal. Since there is no externally generated signal the selector switch selects the internally generated signal and sends it to the translator which passes the internally generated signal to the controllable power source. The controllable power source sends power to the vehicle's battery via a controllable switch which was closed by the selector. The switch is shown open but would be closed when power is being delivered. Note that all previous chargers delivered power by the same type power delivery connector. This is the first charger that has the capability to charge many types of vehicles including vehicles with proprietary power connectors if proprietary charger manufactures decide to use it.

FIG. 12 is the same charger as in FIG. 11. The vehicle of FIG. 11 has been modified so it can send a power control signal. The vehicle is obtaining power at the same proprietary connector as was used in FIG. 11. The vehicle sends a power control signal to the charger's identifier. The identifier recognizes the signal, removes the identifier, and sends it to a signal controller. The signal controller is also receiving a simulated proprietary signal. The signal controller ignores the simulated proprietary signal and selects the vehicle power control signal. It passes the vehicle power control signal to the translator. The translator translates the vehicle power control signal into a power control signal and sends it to the controllable power source. The controllable power source produces charging power and sends it to the battery. The charging power is different than that produced in FIG. 11. The signal generator in the vehicle probably has access to sensor information that monitors the status of the energy storage device. The signal generator also probably has energy storage device specifications. The vehicle signal generator probably can do a better job of determining the power parameters that are needed to optimally charge the energy storage device than a proprietary charger because the signal generator probably has access to more information about the energy storage device.

### DETAILED DESCRIPTION OF THE INVENTION

The foregoing and other objects and features of the present invention can be more readily understood with reference to the following description, taken in conjunction with the accompanying drawings, wherein like reference alpha-numerics identify like electrical elements or signals and in which dotted lines represent signal paths. A number or letter preceded by a dash is a signal format. For example 104-7 indicates signal 104 that is in format 7. Solid lines represent power delivery paths.

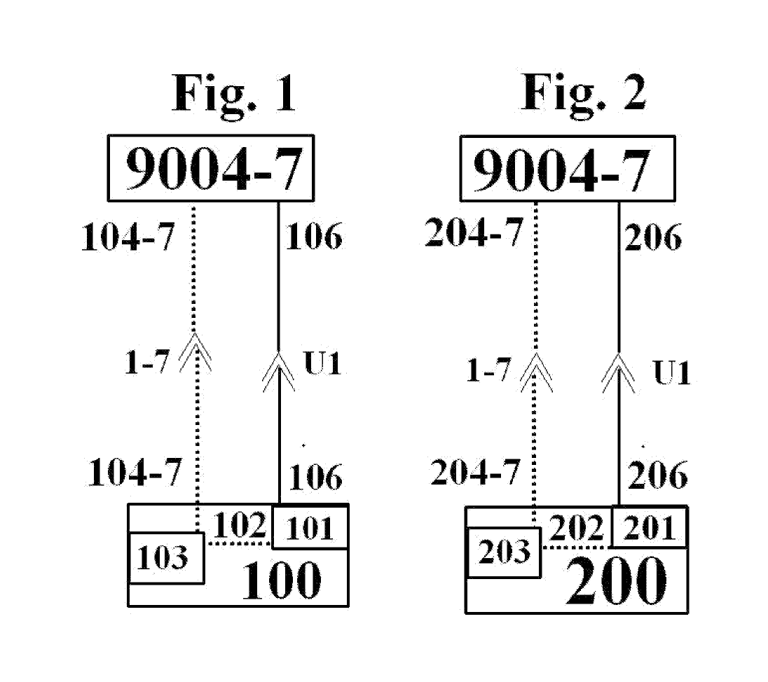

FIG. 1 is a block diagram of an electric vehicle that is controlling power output of a charger. Vehicle 100 signal generator 103 monitors status of battery 101 via signal 102. Signal generator 103 uses battery 101 specifications and sensor information to create power control signal 104-7 which is in format 7 (the seven in 104-7). Signal 104-7 is sent to controllable power source 9004-7 via jack/plug 1-7. Power source 9004-7 needs a control signal in format 7 and hence is referred to as source 9004-7 rather than source 9004. Controllable power source 9004-7 creates power 106 which it delivers to battery 101 via jack/plug U1.

FIG. 2 shows vehicle 200 with different power needs than vehicle 100 of FIG. 1. Vehicle 200 has battery 201 which is being monitored by sensors. Sensor data is sent to signal generator 203 via signal 202. Signal generator 203 creates power control signal 204-7 which is in the same format 7 as signal 104-7 of FIG. 1. Signal 204-7 is sent to controllable power source 9004-7 via jack/plug 1-7. Source 9004-7 creates power 206 which has different parameters than power 106 of FIG. 1. Power 206 is sent to battery 201 via jack/plug U1.

FIG. 3 shows Vehicle 300 which has different power needs than the vehicles of FIG. 1 and FIG. 2. Vehicle 300 is trying to send a standard power source control signal 304-S to the same charger 9004-7 that the vehicles in FIG. 1 and FIG. 2 were using. Vehicle 300 signal output connector S1 is not able to mate to signal input connector 1-7. Incompatible connectors are used because charger controllable source 9004-7 does not understand standard power control signal 304-S. Charger 9004-7 or vehicle 300 could be damaged if standard power control signal 304-S were delivered. Even if no damage occurred the delivered power would not have correct parameters. No power (00) is being delivered to battery 301 via universal power connector U1.

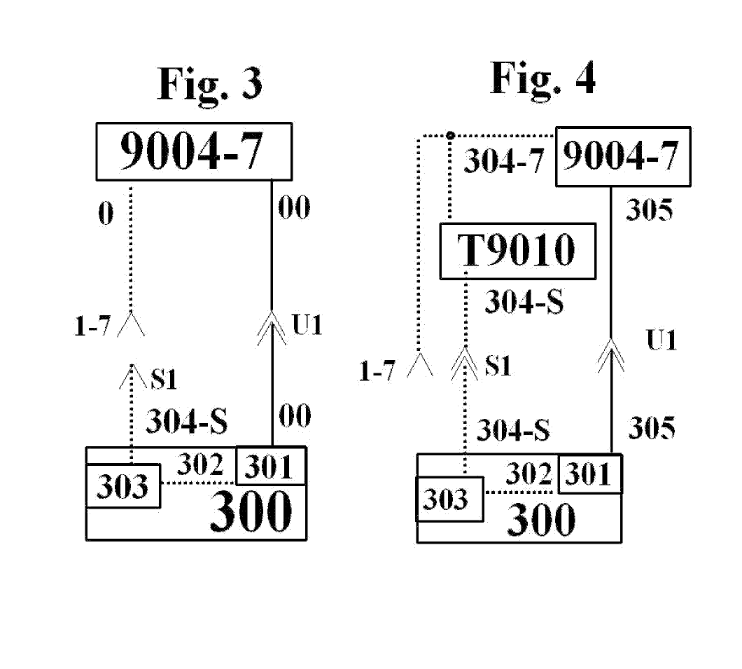

FIG. 4 shows the same vehicle 300 of FIG. 3 obtaining power 305 from a modified charger that is using the same type controllable power source 9004-7. Now translator T9010 has been added to the charger. Vehicle 300 sends standard power control signal 304-S to translator T9010 via standard signal jack/plug S1. Translator T9010 translates standard power control signal 304-S into format 304-7 that controllable power source 9004-7 can use. Source 9004-7 is delivering correct power 305 to battery 301 via jack/plug U1. This charger also has the same power control signal connector 1-7 as the chargers in FIGS. 1 to 3. Jack/plug S1 is not able to mate to power control signal connector 1-7.

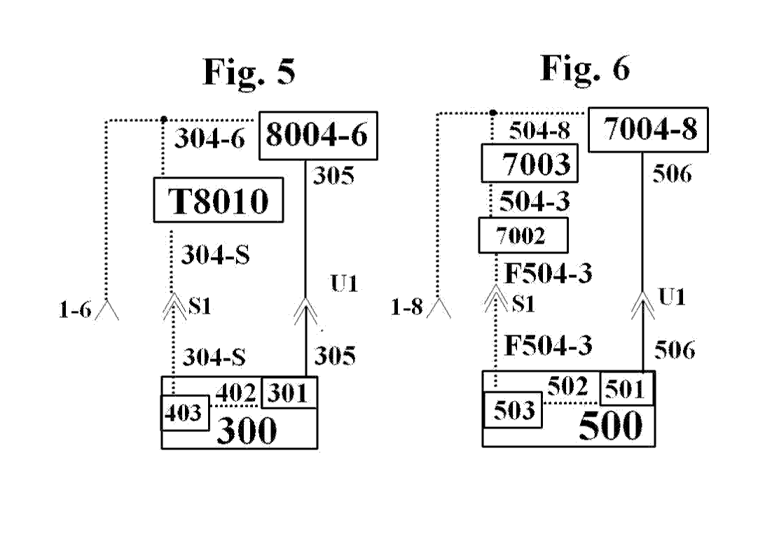

FIG. 5 shows the same vehicle 300 that obtained power in FIG. 4. Vehicle 300 is using the same standard power control signal 304-S to obtain power from a charger that understands standard power control signals. Translator T8010 is translating vehicle 300 standard power control signal 304-S into format 304-6 that is able to control a different type of controllable power source 8004-6. Vehicle 300 battery 301 is obtaining correct power 305 via jack/plug U1. Notice that this is the same power that vehicle 300 obtained from source 9004-7 in FIG. 4. The charger also has a signal connector 1-6 that allows controllable power source 8004-6 to be directly controlled. Notice that charger 9004-7 of FIG. 4 used a power control signal 304-7. Charger 8004-6 uses a power control signal 304-6. Also notice that the signal connector that charger 9004-7 uses is connector 1-7 while the power control signal connector that charger 8004-6 uses is connector 1-6. The connectors are not the same because different types of controllable power sources use different types of power control signals. The signal connectors are incompatible to ensure that only the correct signal will be able to be used. A vehicle that wants to charge at chargers that use different types of controllable power sources will need a different connector and will need to create a different signal to control each power source. Standard power control signals are able to use the same type signal connector because a translator will translate them into proper format. Power control signals cannot be so easily translated because they are likely to use signals that have different formats and other parameters such as grounds and voltages.

FIG. 6 shows a charger that understands many types of power control signals as well as power manipulation signal that the controllable power source uses. The power manipulation signal is sent via plug 1-8. Vehicle 500 is transmitting a power control signal F504-3 The “F” indicates the type signal. There are many types of power control signals and each type may be sent in a different format. The format for F504-3 is “3”. Vehicle 500 has a signal generator 503 that receives sensor data 502 from battery 501. Signal generator 503 creates power control signal F504-3. Control signal F504-3 is sent to identifier 7002 via signal jack/plug S1. Identifier 7002 identifies signal F504-3, removes identification code “F” and sends power control signal 504-3 to translator 7003. Translator 7003 translates power control signal 504-3 into power manipulation signal 504-8 and sends it to controllable power source 7004-8 which creates power 506 which is sent to battery 501 via universal power jack/plug U1.

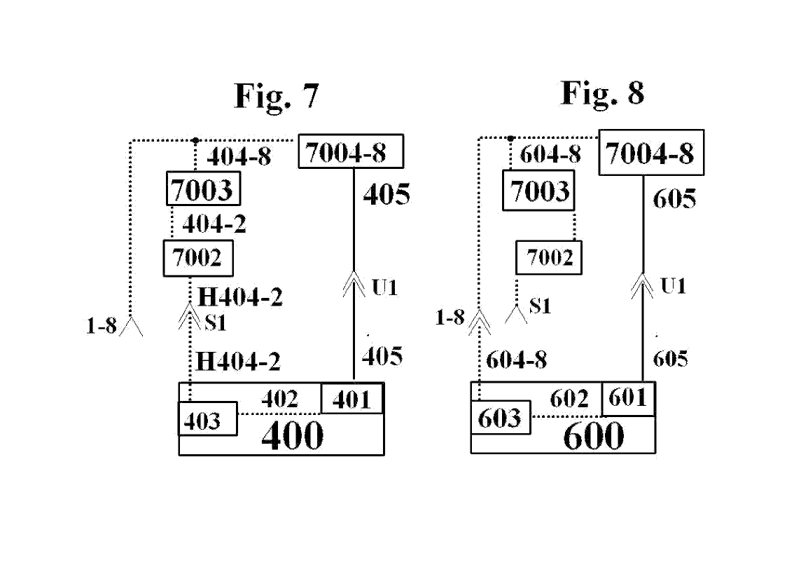

FIG. 7 vehicle 400 is transmitting a different type power control signal H404-2 to the same charger 7004-8 as in FIG. 6. Identifier 7002 recognizes power control signal H404-2, removes the identification code “H”, and sends power control signal 404-2 to translator 7003 that translates it into power manipulation signal 404-8 which has the same format “8” as that used in FIG. 6. Correct power 405 has different parameters from power 506 of FIG. Power 405 is being delivered to the vehicle 400 energy storage device 401 via universal jack/plug U1.

FIG. 8 is the same charger as in FIG. 7. Now different vehicle 600 is directly controlling controllable power source 7004-8 using power control signal 604-8. Vehicle 600 is using signal input connector 1-8 that is unique to the type controllable power source 7004-8. Correct power 605 is being delivered to battery 601 via universal power jack/plug U1.

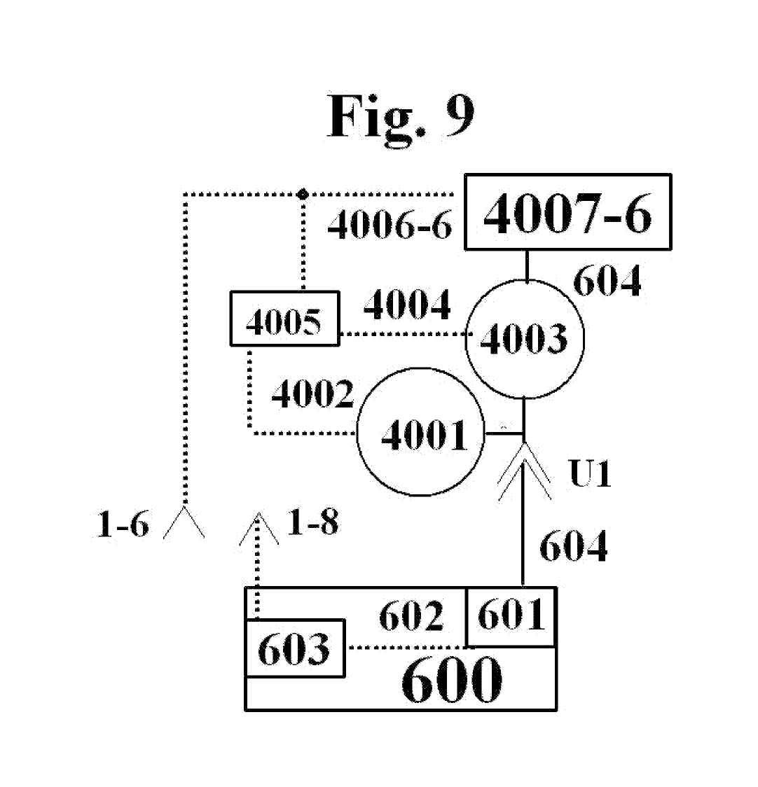

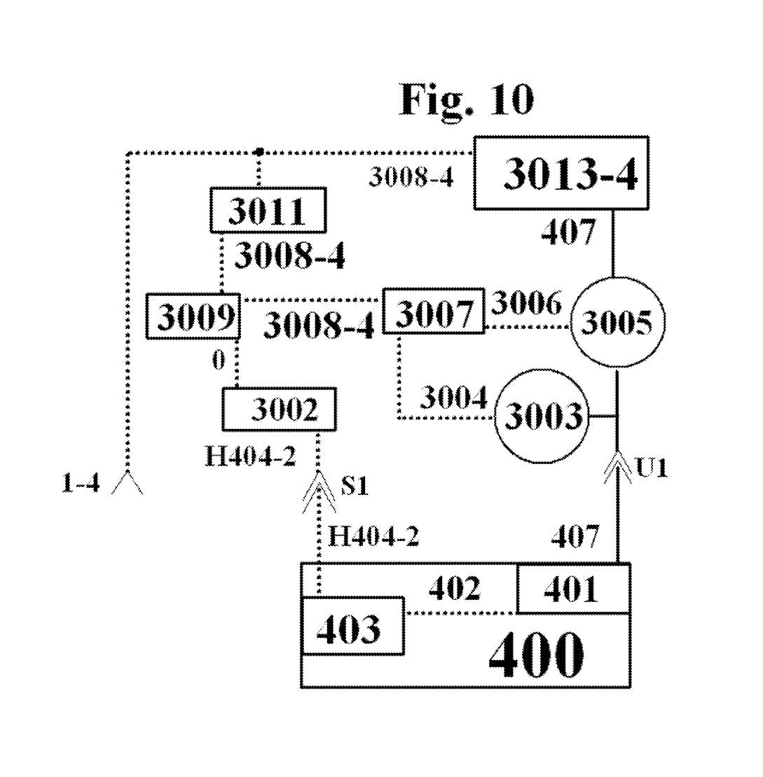

FIG. 9 shows vehicle 600 power control signal plug 1-8 that does not mate with the charger's power parameter input plug 1-6. Charger 4007-6 signal generator 4005 generates an estimated power control signal 4006-6 with no need to receive a signal from vehicle 600. The charger internal signal generator 4005 creates and estimated power control signal 4006-6 based on voltage 4002 measured by voltmeter 4001 and amperage 4004 readings taken by ammeter 4003 near power delivery jack/plug U1. Signal generator 4005 which is internal to the charger is sending the estimated power control signal 4006-6 to the controllable power source 4007-6. Controllable power source 4007-6 creates an estimated power 604 and delivers it to battery 601 via universal jack/plug U1. The vehicle 600 is the same vehicle 600 as in FIG. 8. In FIG. 8 vehicle 600 received power 605 from controllable power source 7004-8. Now vehicle 600 is receiving power 604 from controllable power source 4007-6. The power does not have exactly the parameters as power 605 in FIG. 8 because signal generator 4005 does not have access to the vehicle energy storage device 601 specifications and status information. Signal generator 4005 only has voltage 4002 and current 4004 information. It is likely that less power is being delivered because estimated power 604 has to be a conservative estimate so the vehicle 600 energy storage device 601 will not be damaged.

FIG. 10 is a charger that can either use a power manipulation signal via plug 1-4, a power control signal via jack/plug S1, or can automatically generate an estimated power control signal using internal signal generator 3007. Here the charger is receiving power control signal H404-2 from the same vehicle 400 that received power in FIG. 7. Unfortunately identifier 3002 does not recognize identification code “H” on signal H404-2 and blocks the power control signal. An internal signal generator 3007 senses the presence of vehicle 400 by receiving voltage 3004 detected by voltmeter 3003. Internal signal generator 3007 uses voltage measurement 3004 to create an estimated power control signal 3008-4. Internal signal generator 3007 sends estimated power control signal 3008-4 to signal selector 3009. Signal selector 3009 is only receiving one signal which is estimated power control signal 3008-4 so it sends estimated power control signal 3008-4 to translator 3011. Translator 3011 passes estimated power control signal 3008-4 unchanged to controllable power supply 3013-4. Controllable power supply 3013-4 generates power 407 having parameters as specified by estimated power control signal 3008-4. Power 407 being supplied to vehicle 400 battery 401 via universal jack/plug U1 has somewhat different parameters than the power that the vehicle received in FIG. 7.

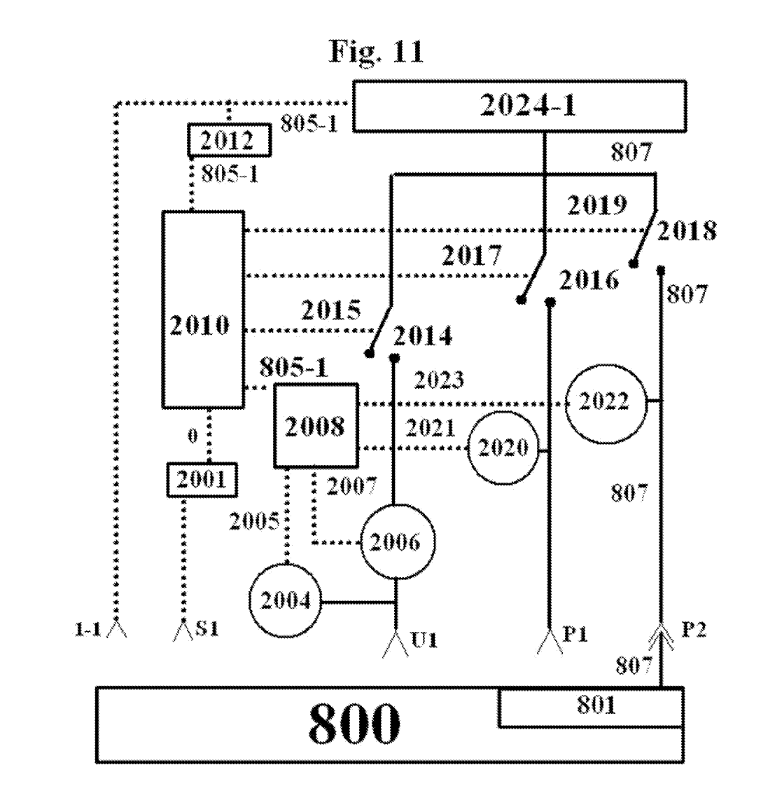

FIG. 11 is a charger that is able to understand a vehicle power manipulation signal, and understand power control signals, and is able to create estimated power, and also is able to simulate the operation of proprietary chargers that use different types of power delivery connectors. A proprietary vehicle 800 is using proprietary power delivery connector P2 to obtain power 807. Vehicle 800 does not have a signal generator. Vehicle 800 only has a battery 801 and a proprietary power connector P2. The charger's internal signal generator 2008 knows vehicle 800 is using proprietary power delivery connector P2 because signal generator 2008 is receiving voltage 2023 from voltmeter 2022 on the power delivery line to proprietary power delivery jack/plug P2. Signal generator 2008 has information about the proprietary charger that uses proprietary connector P2. More than likely the manufacturer of the charger that uses proprietary connector P2 will create the program that internal signal generator 2008 uses to create power control signal 805-1. Signal generator 2008 creates and sends power control signal 805-1 to selector 2010. Selector 2010 chooses between externally generated power control signal 0 which it receives from identifier 2001 and the internally generated power control signal which in this case is 805-1. Note that signal generator 2008 also has the ability to create an estimated power control signal based on voltage measurement 2005 taken by voltmeter 2004 at universal connector U1. Since there is no vehicle connected to jack/plug U1 voltmeter 2004 will measure zero volts so signal generator 2008 will ignore it. Since there is no externally generated signal coming from identifier 2001 selector switch 2010 selects internally generated signal 805-1 and sends it to translator 2012 which passes internally generated signal 805-1 unchanged to controllable power source 2024-1. Controllable power source 2024-1 sends power 807 to vehicle 800 battery 801 via a controllable switch 2018 which will be closed by selector 2010 using switch control signal 2019. Switch 2018 is shown open but would be closed when power 807 is being delivered. Note that all chargers in all the previous figures and this figure have delivery connector U1. All these chargers are part of one power delivery system. This is the first charger that has the capability to charge many types of vehicles including vehicles with proprietary power connectors if proprietary charger manufacturers decide to use it.

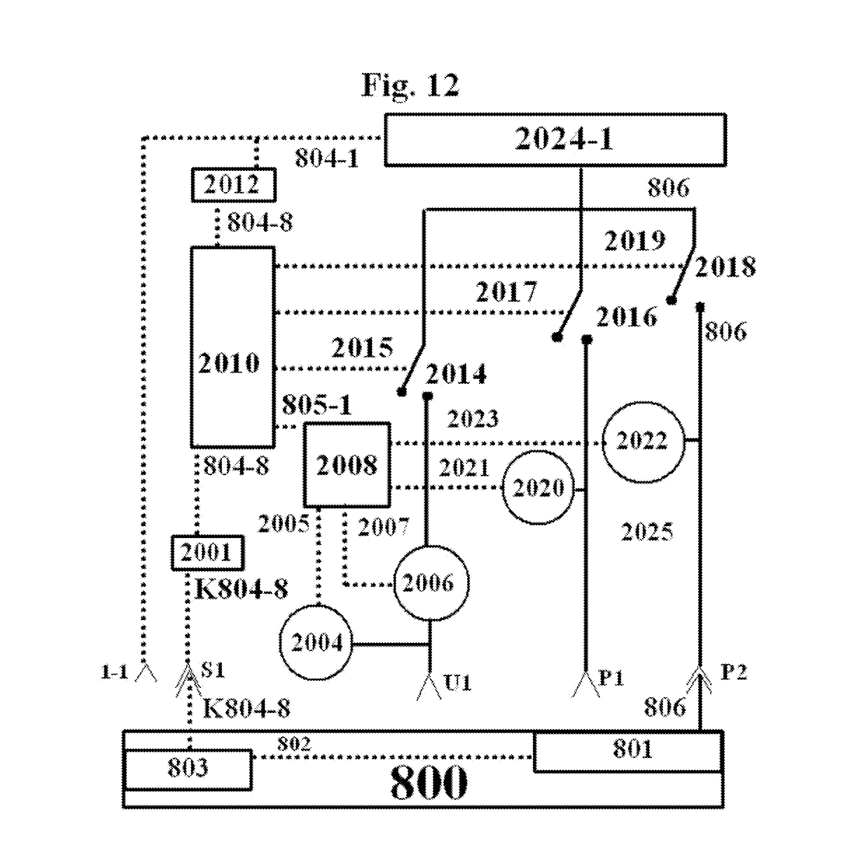

FIG. 12 is the same charger as in FIG. 11. Vehicle 800 of FIG. 11 has been modified so it can send power control signal K804-8. Vehicle 800 is obtaining power 806 at the same proprietary connector P2 as was used in FIG. 11. Vehicle 800 sends power control signal K804-8 to the charger's identifier 2001. Identifier 2001 recognizes signal K804-8, removes identification code “K”, and sends power control signal 804-8 to signal controller 2010. Signal controller 2010 is also receiving a proprietary signal 805-1 from charger signal generator 2008. Signal controller 2010 ignores proprietary signal 805-1 and selects vehicle 800 power control signal 804-8. Signal controller 2010 passes vehicle power control signal 804-8 to translator 2012. Translator 2012 translates vehicle power control signal 804-8 into power manipulation signal 804-1 and sends it to controllable power source 2024-1. Controllable power source 2024-1 produces charging power 806 and sends it to battery 801 via proprietary power jack/plug P2. Charging power 806 is different than charging power 807 produced in FIG. 11. Signal generator 803 in vehicle 800 has access to sensor information 802 that monitors the status of the energy storage device 801. Signal generator 803 also has energy storage device 801 specifications. Vehicle signal generator 803 probably can do a better job of determining power parameters that are needed to optimally charge energy storage device 801 than a proprietary charger because signal generator 803 has access to more information about energy storage device 801.

Although only power control signals have been mention in the figures, an important type signal would simply transmit specifications and status of a vehicle's energy storage device. The translator would develop a power manipulation signal based on this information.

Thus there has been shown a power delivery system composed of several basic types of chargers. The system is capable of providing power to many types of electric vehicles using many types of power delivery connectors as well as many types of vehicles that choose to use a universal connector that can be common to any charger in the power delivery system if charger manufacturers choose to use it. It is to be understood that those skilled in the art are able to create many and varied power delivery systems without departing from the spirit and scope of the present invention. The use of the power delivery system is described with reference to electric vehicles because they are represent a worst case scenario due to the many types and sizes of energy storage devices they use, especially batteries that may require charging parameters that vary during the charging cycle as well as charging parameters that vary in different environments and due to battery status such as hot, cold, low charge, near full charge, deteriorated condition, etc. The signals described in the present invention are one-way signals. One way-signals from the vehicle to the charger are used for simplicity of presentation. It is not to be implied that two-way information should not or can not be used. There are many uses for two-way information exchange, for example a charger can tell a vehicle which type signals it can use, or inform the vehicle about other charger specifications.

What is claimed is:

1. A system of chargers that each have a power manipulation device controllable by one type signal;
said system consisting of:
chargers each having a power manipulation device,
said power manipulation device having means to access source power,
said power manipulation device having means to receive a signal at a manipulator signal input means,
said power manipulation device having means to use a power manipulation signal at said manipulator signal input means to create charging power from said source power,
said power manipulation device having means to provide said charging power at a manipulator power output means;
vehicles each having a signal generator,
said signal generator having means to create said power manipulation signal,
said signal generator having a generator signal output means;
said signal generator having means to transmit said power manipulation signal to said generator signal output means;
means to make a signal transfer connection;
means to unmake said signal transfer connection,
said signal transfer connection having means to connect one said generator signal output means to one said manipulator signal input means,
means to make said signal transfer connection from any vehicle of said vehicles to any charger of said chargers,
said vehicles each having an energy storage device,
said energy storage device having a storage power input means;
means to make a power transfer connection;
means to unmake said power transfer connection,
said power transfer connection having means to transmit said charging power from one said manipulator power output means to one said storage power input means;
means to make said power transfer connection from any said charger of chargers to any said vehicle of vehicles;
means to create a charging vehicle of said vehicles,
said charging vehicle of vehicles having said power transfer connection to a charging said charger of chargers,
said charging vehicle of vehicles having said signal transfer connection to said charging charger of chargers.

2. A system of chargers that each have one type power manipulation device of types of power manipulation devices, each type power manipulation device controllable by a different type power manipulation signal; said chargers having a translator which can translate a standard power control signal into the type power manipulation signal that the charger's power manipulation device can use; vehicles that each have the ability to create the standard power control signal;
said system consisting of:
chargers each having a translator,
said translator having a translator signal input means;
said translator having means to receive a signal at said translator signal input means;
said translator having means to translate a standard power control signal at said translator signal input means into a type power manipulation signal of types of power manipulation signals;
said translator having means to transmit said type power manipulation signal of types of power manipulation signals to a type power manipulation device of types of power manipulation devices,
said type power manipulation device of types of power manipulation devices located in the same charger of said chargers as said translator;
said type power manipulation device of types of power manipulation devices having means to access source power;
said type power manipulation device of types of power manipulation devices having means to use said type power manipulation signal of types of power manipulation signals to create charging power from said source power;
said type power manipulation device of types of power manipulation devices having means to provide said charging power at a manipulator power output means;
vehicles each having a signal generator,
said signal generator having means to create said standard power control signal;
said signal generator having means to provide said standard power control signal at a generator signal output means;
means to make a signal transfer connection;
means to unmake said signal transfer connection,
said signal transfer connection having means to connect one said generator signal output means to one said translator signal input means;
means to make said signal transfer connection from any vehicle of said vehicles to any charger of said chargers,
said vehicles each having an energy storage device,
said energy storage device having a storage power input means;
means to make a power transfer connection;
means to unmake said power transfer connection,
said power transfer connection having means to transmit said charging power from one said manipulator power output means to one said storage power input means;
means to make said power transfer connection from any charger of said chargers to any vehicle of said vehicles;
means to create a charging vehicle of said vehicles,
said charging vehicle of vehicles having said power transfer connection to a charging said charger of chargers,
said charging vehicle of vehicles having said signal transfer connection to said charging charger of chargers.

3. Vehicles that create various types of power control signals and can use a system of chargers that each have a translator which can identify the type power control signal and translate it into the type power manipulation signal that the charger's power manipulation device can use;
said system consisting of:
vehicles each having a signal generator,
said signal generator having means to create at least one type power control signal of types of power control signals;
said signal generator having means to provide said at least one type power control signal of types of power control signals at a generator signal output means;
chargers each having an identifier/translator,
said identifier/translator having an identifier/translator signal input means;
said identifier/translator having means to use said at least one said type power control signal of types of power control signals at said identifier/translator signal input means to create a power manipulation signal;
means to make a signal transfer connection;
means to unmake said signal transfer connection,
said signal transfer connection having means to connect one said generator signal output means to one said identifier/translator signal input means;
means to make said signal transfer connection from any vehicle of said vehicles to any charger of said chargers;
said identifier/translator having means to transmit said power manipulation signal to one power manipulation device,
said one power manipulation device located in the same charger of said chargers as said identifier/translator;
said power manipulation device having means to access source power;
said power manipulation device having means to use said power manipulation signal to create charging power from said source power;
said power manipulation device having means to provide said charging power at a manipulator power output means;
said vehicles each having an energy storage device,
said energy storage device having a storage power input means;
means to make a power transfer connection;
means to unmake said power transfer connection,
said power transfer connection having means to transmit said charging power from one said manipulator power output means to one said storage power input means;
means to make said power transfer connection from any said charger of chargers to any said vehicle of vehicles;
means to create a charging vehicle of said vehicles,
said charging vehicle of vehicles having said power transfer connection to a charging said charger of chargers,
said charging vehicle of vehicles having said signal transfer connection to said charging charger of chargers.

4. A vehicle charging system composed of chargers that are able to use power control signals to control charging power parameters but also have the ability to create charging power whose parameters vary based on type power output connection;
said system consisting of:
at least one non-signaling vehicle of vehicles,
said non-signaling vehicle of vehicles not having a signal generator;
at least one signaling vehicle of vehicles,
said signaling vehicle of vehicles having said signal generator,
said signal generator having means to create at least one type power control signal of types of power control signals;
said signal generator having a generator signal output means;
said signal generator having means to provide said at least one type power control signal of types of power control signals at said generator signal output means;
chargers each having an identifier/translator,
said identifier/translator having means to receive a signal at an identifier/translator signal input means;
said identifier/translator having means to receive said at least one type power control signal of said types of power control signals at said identifier/translator signal input means;
said identifier/translator having means to use said at least one type power control signal of said types of power control signals to create an external power manipulation signal;
means to make a signal transfer connection;
means to unmake said signal transfer connection,
said signal transfer connection having means to connect one said generator signal output means to one said identifier/translator signal input means;
means to make said signal transfer connection from any signaling vehicle of said signaling vehicles to any charger of said chargers;
said vehicles each having an energy storage device,
said energy storage device having a type storage power input means of types of storage power input means;
said chargers each having a power manipulation device,
said power manipulation device having means to access source power;
said power manipulation device having means to use a selected power manipulation signal to create charging power from said source power;
said power manipulation device having means to provide said charging power at types of manipulation power output means;
means to make a power transfer connection;
means to unmake said power transfer connection,
said power transfer connection having means to transmit said charging power from one said manipulation power output means of said types of manipulation power output means to one said storage power input means of said types of storage power input means;
means to determine which said manipulation power output means of said types of manipulation power output means has said power transfer connection;
means to make said power transfer connection from any one said charger of chargers to any one said vehicle of vehicles;
means to create a charging said non-signaling vehicle of vehicles,
said charging non-signaling vehicle of vehicles having said power transfer connection to said charger of chargers;
means to create a charging said signaling vehicle of vehicles,
said charging signaling vehicle of vehicles having said power transfer connection to a charging said charger of chargers,
said charging signaling vehicle of vehicles having said signal transfer connection to said charging charger of chargers;
means to create a connection method power manipulation signal,
said connection method power manipulation signal having at least one parameter whose value is dependent on which said manipulation power output means of said types of manipulation power output means has said power transfer connection,
said storage power input means of types of storage power input means having said power transfer connection;
means to use said connection method power manipulation signal to create aforesaid selected power manipulation signal;
means to use said external power manipulation signal to create aforesaid selected power manipulation signal.

5. A vehicle charging system composed of chargers that are able to use information to control charging power parameters;
said system consisting of:
chargers each having a power manipulation device,
said power manipulation device having means to access source power,
said power manipulation device having means to receive a signal at a manipulator signal input means,
said power manipulation device having means to use a power manipulation signal at said manipulator signal input means to create charging power from said source power;
said power manipulation device having means to provide said charging power at a manipulator power output means;
vehicles each having an energy storage device,
said energy storage device having a storage power input means,
said vehicles each having a signal generator,
said signal generator having means to create an information signal,
said information signal having information about said energy storage device,
said signal generator having means to provide said information signal at a generator signal output means;
said chargers having an information processor,
said information processor having a processor signal input means,
said information processor having means to use said information at said processor signal input means to create said power manipulation signal;
means to make a signal transfer connection;
means to unmake said signal transfer connection;
said signal transfer connection having means to connect one said generator signal output means to one said processor signal input means;
means to make said signal transfer connection from any vehicle of said vehicles to any charger of said chargers;
means to make a power transfer connection;
means to unmake said power transfer connection;
said power transfer connection having means to transmit said charging power from one said manipulator power output means to one said storage power input means;
means to make said power transfer connection from any charger of said chargers to any vehicle of said vehicles;
means to create a charging vehicle of said vehicles,
said charging vehicle of vehicles having said power transfer connection to a charging said charger of chargers,
said charging vehicle of vehicles having said signal transfer connection to said charging charger of chargers.

6. The equipments of claim 2 wherein vehicles have means to use the standard power control signal but also may directly control a power manipulation device by using a signal that the power manipulation device understands without the need for translation;
said equipments consisting of:
The equipments of claim 2 wherein a manipulation signal generating vehicle of said vehicles has a direct control said signal generator,
said direct control signal generator having means to create said type power manipulation signal of types of power manipulation signals,
said direct control signal generator having means to deliver said type power manipulation signal of types of power manipulation signals to a direct control signal output means;
said power manipulation device having a direct control signal input means;
means to form a signal transfer connection from said direct control signal output means to said direct control signal input means;
said power manipulation device having means to use said type power manipulation signal of said types of power manipulation signals at said direct control signal input means to create said charging power.

7. The equipments of claim 3 wherein one said type power control signal of types of power control signals is a direct control signal;
said equipments consisting of:
The equipments of claim 3 wherein a manipulation signal generating vehicle of said vehicles has a direct control said signal generator,
said direct control signal generator having means to create said power manipulation signal,
said direct control signal generator having means to deliver said power manipulation signal to a direct control signal output means;
said power manipulation device having a direct control signal input means;
means to form a signal transfer connection from said direct control signal output means to said direct control signal input means;
said power manipulation device having means to use said power manipulation signal at said direct control signal input means to create said charging power.

8. The equipments of claim 4 wherein one said type power control signal of types of power control signals is a direct control signal;
said equipments consisting of:
The equipments of claim 4 wherein a manipulation signal generating vehicle of said signaling vehicles has a direct control said signal generator,
said direct control signal generator having means to create said power manipulation signal,
said direct control signal generator having means to deliver said power manipulation signal to a direct control signal output means;
said power manipulation device having a direct control signal input means;
means to form a signal transfer connection from said direct control signal output means to said direct control signal input means;
said power manipulation device having means to use said power manipulation signal at said direct control signal input means to create said charging power.

9. The equipments of claim 5 wherein one said type power control signal of types of power control signals is a direct control signal;
said equipments consisting of:
The equipments of claim 5 wherein a manipulation signal generating vehicle of said vehicles has a direct control said signal generator,
said direct control signal generator having means to create said power manipulation signal,
said direct control signal generator having means to deliver said power manipulation signal to a direct control signal output means;
said power manipulation device having a direct control signal input means;
means to form a signal transfer connection from said direct control signal output means to said direct control signal input means;
said power manipulation device having means to use said power manipulation signal at said direct control signal input means to create said charging power.

10. The equipments of claim 2 wherein a direct control said signal generator has means to create said type power manipulation signal of types of power manipulation signals,
a direct control vehicle of said vehicles having said direct control signal generator,
said direct control signal generator having means to create said type power manipulation signal of types of power manipulation signals;
said translator having means to transmit said type power manipulation signal of types of power manipulation signals to said power manipulation device.

11. The equipments of claim 3 wherein a direct control said signal generator has means to create said power manipulation signal,
a direct control vehicle of said vehicles having said direct control signal generator, said direct control signal generator having means to create said power manipulation signal;
said translator having means to transmit said power manipulation signal to said power manipulation device.

12. The equipments of claim 4 wherein a direct control said signal generator has means to create said power manipulation signal,
a direct control vehicle of said signaling vehicles having said direct control signal generator,
said direct control signal generator having means to create said type power manipulation signal of types of power control signals;
said identifier/translator having means to transmit said power manipulation signal of types of power control signals to said power manipulation device.

13. The equipments of claim 3 wherein an information providing vehicle of said vehicles has an information signal generator,
said information signal generator having means to create an information signal,
said information signal having information about said energy storage device,
said information signal generator having means to provide said information signal at said generator signal output means;
said identifier/translator having means to use said information signal to create said power manipulation signal.

14. The equipments of claim 4 wherein an information providing vehicle of said signaling vehicles having an information signal generator,
said information signal generator having means to create an information signal,
said information signal having information about said energy storage device,
said information signal generator having means to provide said information signal at said generator signal output means;
said identifier/translator having means to use said information signal to create said power manipulation signal.

15. A charging system composed of the equipments of claims 1, 2, 3, 4, and 5, said equipments having at least one common type said power output means.

16. Any subset of equipments of claims 1, 2, 3, 4, and 5;
the equipments of said subset having at least one common type power output means.

17. Any subset of claims 2, 3, and 4;
the equipments of said subset having at least one common type power output means.

18. Any subset of claims 2, 3, 4, 5, 6, 7, 8, and 9;
the equipments of said subset of claims having at least one common type power output means.

19. Any subset of claims 2, 3, 4, 6, 7, 8, 9, 10, 11, 12, 13 and 14, the equipments of said subset of claims having at least one common type power output means.

20. Any subset of claims 1, 2, 3, 4, 5, 6, 7, 8, 9, 10, 11, 12, 13 and 14, the equipments of said subset of claims having at least one common type power output means.
